(19) United States
(12) Patent Application Publication
(10) Pub. No.: US 2026/0276267 A1
(43) Pub. Date: Sep. 17, 2026

(54) UNIT COMPRISING A COLLECTION TANK

(71) Applicant: Siemens Energy Global GmbH & Co. KG, München (DE)

(72) Inventors: Ernst-Robert Keck, Krefeld (DE); Marc Runkel, Wuppertal (DE); Sebastian Lau, Bochum (DE); Oliver Quade-Jubin, Hattingen (DE)

(21) Appl. No.: 19/166,678

(22) PCT Filed: Feb. 27, 2024
(86) PCT No.: PCT/EP2024/054879

§ 371 Date: Sep. 18, 2025

(30) Foreign Application Priority Data
Mar. 28, 2023 (DE) 10 2023 202 802.6

(51) Int. Cl. F25B 43/00; F25B 43/02

(52) U.S. Cl. CPC F25B 43/006; F25B 43/02

(57) ABSTRACT

The invention relates to a device including a collecting tank which has a feed for a mixture of sealing oil and coolant, an outlet for sealing oil, and an additional tank which is designed to collect coolant and is fluidically connected to the collecting tank.

### BACKGROUND

The invention relates to a device comprising a collecting tank which has a feed for a mixture of sealing oil and coolant, and further comprises a drain for sealing oil.

The invention further relates to a method of collecting a sealing oil and a coolant, wherein a mixture of sealing oil and coolant is conducted into a collecting tank in one step.

A turbo compressor, which may also be designed as a heat pump, is used for compression of a process gas in an industrial process. In the case of a heat pump, the process gas is also referred to as coolant. The turbo compressor has a rotor mounted with bearings outside a housing that surrounds the rotor. Since there is a prevailing relative movement between the rotor and the housing in the operation of the turbo compressor, a gap has to be maintained at the point where the shaft of the rotor departs from the inside of the housing. The gap has to be bridged with a shaft seal in order to prevent leakage of the process gas from the inside of the turbo compressor to the outside, or at least to keep it at an acceptable level. If the process gas is combustible, toxic and/or hazardous to the environment, there are high demands on the shaft seal with regard to the sealing effect thereof. It is known that the bearings used may be oil-lubricated plain bearings, in particular oil-lubricated plain bearings with thrust pads. The design of the plain bearings is matched to the speed of operating and rotor dynamics of the rotor, with the shaft seal and the bearing in an immediately adjacent arrangement on the shaft.

In a cycle process, for example a refrigeration circuit, high demands are placed on the shaft seal. The leaks of the process gas from the turbo compressor have to be kept to a minimum. If, for example, the shaft seal is designed as a liquid seal which is blocked by a sealing oil for example, the sealing oil selected has to be chemically compatible with the coolant. Conventionally, the sealing oil is also used as lubricating oil for the bearings, and so the turbo compressor is supplied by a combined lubricating/sealing oil system, in which case the sealing oil also has to be suitable for lubricating and cooling the bearings, which means that the sealing oil has to meet various requirements. For example, mineral oil may not be suitable as the sealing oil for lubricating the bearings and for sealing the shafts, since the mineral oil may not be compatible with the coolant used in the refrigeration process. A remedy is provided by special synthetic oils, but these are highly hygroscopic and therefore must not come into contact with the humidity of the outside atmosphere.

The sealing oil in oil-lubricated slip ring seals in coolant compressors can thus absorb coolant during operation. The coolant has to be returned back to the coolant circuit in the gaseous state by an extraction process. A problem here is that the extraction process has to take place under almost atmospheric conditions since the sealing system is open to the atmosphere on one side.

This atmospheric side is open in conventional seals and led into the environment. There was thus always emission in such seals. Therefore, attempts were made to keep this leakage as small as possible.

### SUMMARY

Against this background, it was an object of the invention to specify a device in which emission of the coolant is prevented.

This object is achieved by a device having a collecting tank which has a feed for a mixture of sealing oil and coolant, an outlet for sealing oil, and an additional tank which is designed to collect coolant and is fluidically connected to the collecting tank.

The objects are also achieved by a method of collecting a sealing oil and a coolant, including the steps of feeding a mixture of sealing oil and coolant into a collecting tank and collecting the coolant escaping from the sealing oil in an additional tank.

The invention enables virtual prevention of coolant emission by the use of an additional tank which is designed to collect the coolant and which is formed with a variable volume.

In exemplary embodiments, the additional tank has a bladder which collects the coolant and has a variable volume. In this way, it is possible to replace the coolant between the additional tank and the collecting tank during operation.

The bladder, which can also be referred to as an atmospheric tank bladder, is intended to achieve a division of seal leakage from the atmospheric air, which can only form a minimal pressure differential. This means that exchange of coolant to the environment is no longer possible.

The bladder made of an elastic material is installed in the additional tank and envelops the introduced sealing oil. On return to the sealing oil circuit from the tank, the bladder contracts and adapts to the volume of sealing oil. The cavity between inner tank wall and tank bladder is then filled with air rather than with coolant vapors, and this can then breathe toward the atmosphere.

The advantage is that this prevents emission of coolant into the environment.

The above-described properties, features and advantages of this invention and the manner in which they are achieved will become more clearly and distinctly apparent in conjunction with the description of the working examples that follows, and these are elucidated in detail in conjunction with the drawings.

In that context, identical components or components having identical functions are labelled with identical reference signs.

Working examples of the invention will be described hereinafter with reference to the drawings. These are not intended to illustrate the working examples to scale; instead, the drawing, where conducive to clarification, is constructed in a schematized and/or slightly distorted form. With regard to additions to the teachings which are directly apparent in the drawing, reference is made to the relevant prior art.

### BREIF DESCRIPTION OF THE FIGURES

FIG. 1 a schematic diagram of one embodiment of a device of the invention.

### DETAILED DESCRIPTION

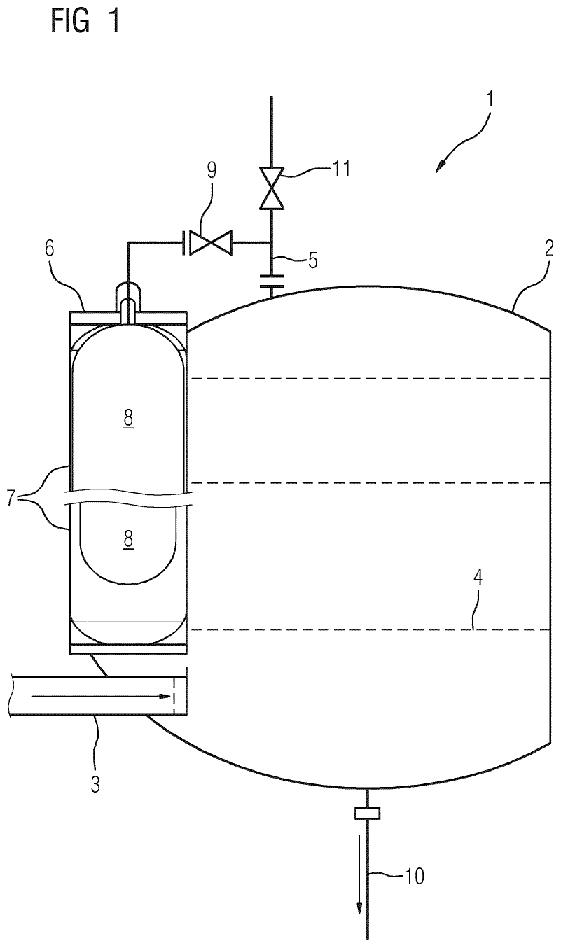

FIG. 1 shows a device 1 comprising a collecting tank 2. The collecting tank 2 is designed for filling with a mixture of sealing oil and coolant. The mixture of sealing oil and coolant comes, for example, from a turbo compressor or a heat pump in which sealing oil is used in the shaft seal, with mixing of the sealing oil with small amounts of coolant in operation. The coolant is used as process gas in the turbo compressor or heat pump.

The mixture of sealing oil and coolant accordingly formed in the turbo compressor or heat pump passes via a feed 3 into the collecting tank 2. The mixture of sealing oil and coolant accumulates in the collecting tank 2, with outgassing of the coolant from the sealing oil over time, i.e. separation and accumulation above the sealing oil.

FIG. 1 shows a first fill height 4 with sealing oil by the dashed line. This means that sealing oil can accumulate up to this line, in which case the space above the dashed line is filled with coolant. The two further dashed lines above the dashed line show further illustrative fill heights 4 with sealing oil.

The coolant passes through a conduit 5 to an additional tank 6. The conduit 5 establishes a fluidic connection between the collecting tank 2 and the additional tank 6. The conduit 5 is in a geodetically high position.

The additional tank 6 is formed with a housing 7, with a bladder 8 inside the housing 7 that is ultimately filled with the coolant. The volume of the bladder 8 is variable, such that more and more coolant can accumulate in operation. Therefore, the bladder 8 is formed from an elastic material. The upper half of the illustration of the additional tank 6 indicates a state of the bladder 8 in which the bladder 8 is comparatively well filled, while the lower half of the illustration of the additional tank 6 shows a lower filling level which can be recognized by the lower volume of the bladder 8.

The functioning of bladder 8 is accordingly comparable to a balloon, the volume of which can likewise change. Depending on the operating conditions, there is also a change here in the volume of the bladder 8, which means that the amount of intermediately stored coolant is variable.

Such a device 1 prevents coolant from entering the atmosphere from a turbo compressor process or heat pump process.

There is air between the bladder 8 and the housing 7.

In the conduit 5 is disposed a valve 9, which is generally open when the bladder 8 is being filled. In an operating state, a certain amount of sealing oil is discharged via a drain 10. The draining the sealing oil creates a reduced pressure above the fill height 4. The effect of this is that the space above the sealing oil in the collecting tank 2 is filled with coolant from the additional tank 6.

If the amount of coolant in the collecting tank 2 and the additional tank 6 should have reached an upper value, the coolant is discharged via a bleed valve 11 disposed in the conduit 5. The coolant can be fed back here to the turbo compressor or heat pump as process gas. Valve 9 must remain closed when the coolant is being discharged via the bleed valve 11.

Thus, the collecting tank 2 and the additional tank 6 are operated in such a way that the collecting tank 2 is filled with a mixture of sealing oil and coolant, and the coolant is separated from the sealing oil and collected in the additional tank 6, where the discharge of the sealing oil separated from the coolant is followed by filling of the collecting tank 2 with coolant from the additional tank 6.

Since the sealing oil discharged from the collecting tank 2 may still include coolant, it is separated from the coolant in a downstream process, which is not described in detail here.

Although the invention has been illustrated and described in detail on the basis of the preferred working example, the invention is not restricted by the examples disclosed, and other variants may be derived therefrom by a person skilled in the art without departing from the scope of protection of the invention.

1. A device comprising
a collecting tank having a feed for a mixture of sealing oil and coolant;
a drain for sealing oil; and
an additional tank which is designed for collecting coolant and is fluidically connected to the collecting tank.

2. The device as claimed in claim 1,
wherein the additional tank has a bladder made of an elastic material.

3. The device as claimed in claim 2,
wherein the volume of the bladder is variable.

4. The device as claimed in claim 2,
wherein there is a housing around the bladder, wherein air between the housing and the bladder is fluidically connected to the atmosphere via a valve.

5. The device as claimed in claim 1, wherein there is a valve between the collecting tank and the additional tank.

6. The device as claimed in claim 1,
wherein the collecting tank has a bleed valve that forms a fluidic connection between the coolant in the collecting tank and an additional device.

7. A method of collecting a sealing oil and coolant, comprising the steps of:
feeding a mixture of sealing oil and coolant into a collecting tank; and
collecting the coolant escaping from the sealing oil in an additional tank.

8. The method as claimed in claim 7,
wherein the collecting tank is filled with coolant from the additional tank when sealing oil is being removed from the collecting tank via a drain.

9. The method as claimed in claim 8,
wherein there is a valve between the additional tank and the collecting tank.

10. The method as claimed in claim 7,
wherein a bleed valve between the collecting tank and the additional tank establishes a fluidic connection between the coolant in the collecting tank and an additional device.

11. The method as claimed in claim 7,
wherein the additional tank is formed by a bladder of an elastic material, wherein the volume of the bladder is variable.

12. The method as claimed in claim 7,
in which, in a first process step, the mixture of sealing oil and coolant is in the collecting tank and the coolant separates from the sealing oil and collects above the sealing oil, where the coolant above the sealing oil fills the additional tank, where, in a second process step, the collected sealing oil is removed via the drain and the space above the sealing oil in the collecting tank is filled with coolant from the additional tank.
